(19) United States
(12) Patent Application Publication
(10) Pub. No.: US 2005/0033487 A1
(43) Pub. Date: Feb. 10, 2005

(54) Method for preventing hijackers from taking control of an aircraft

(76) Inventor: Marc Esculier, Neuilly (FR)

Correspondence Address: OLIFF & BERRIDGE, PLC, P.O. BOX 19928, ALEXANDRIA, VA, 22320, US

(21) Appl. No.: 10/494,632

(22) PCT Filed: Nov. 4, 2002
(86) PCT No.: PCT/FR02/03768

(30) Foreign Application Priority Data
Nov. 6, 2001 (FR) 01/14325

(51) Int. Cl. G06F 17/00

(52) U.S. Cl. 701/3; 701/11

(57) ABSTRACT

The invention concerns a method for preventing hijackers from steering an aircraft toward a ground target, comprising the following steps: a) locking the automatic control system(s), b) selecting a landing field by means of an onboard computer, c) locking said computer accessible flight controls, d) automatically guiding the aircraft towards a route to reach said selected landing field, e) automatically guiding the aircraft to land on said landing field.

This invention covers a method for preventing hijackers from taking control of an airborne aircraft in order to use is as a weapon of destruction.

For several years, airborne aircraft have been hijacked regularly. Recent events have shown us that a hijacked aircraft can be used as a flying bomb, leading not only to the destruction of the aircraft and its passengers and crew, but also to great damage on the ground.

In such hijackings, the aim of the hijackers is not to destroy the aircraft and passengers, but rather to destroy a target on the ground.

This invention is aimed at preventing hijackers from directing the aircraft towards a target on the ground and thereby making their mission pointless.

Most aircraft have many navigation and electronic systems such as the autopilot, which can be programmed to pilot the aircraft with no human intervention and the Flight Management Guidance Control (FMGC) system, which is used to automatically control the autopilot and therefore automate the piloting function entirely.

This invention attempts to use these systems to keep hijackers from taking over the control of an airborne aircraft and using it as a flying bomb against a target on the ground.

The method described in this invention is made up of the following stages:
a) Locking of the autopilot or autopilots
b) Selection of a landing airport by an airborne computer
c) Locking by the said computer by controls accessible when the aircraft is airborne
d) Automatic guidance of the aircraft towards a route to the said selected landing airport
e) Automatic guidance of the aircraft for landing on the selected airport

The method includes a stage in which the autopilot cannot be reprogrammed by anyone after it has been started up.

The autopilot unit is to be placed advantageously in a part of the aircraft that is not accessible to the crew or passengers.

The choice of a landing airport during stage b), where the aircraft is made to land automatically, is made on the basis of the data stored in the databases of the aircraft and measurements taken automatically. The data may be data about existing airports and their equipment, data supplied by inertial platforms and by the GPS (Ground Position System) of the aircraft via the FMGC system. The airport must in particular have an ILS (Instrument Landing System) for automatic landing. The choice may also depend on the quantity of fuel left when the procedure is started.

During stage c), the computer prevents anyone from controlling the functions of the aircraft by locking the control of the secondary hydraulic systems (flaps, stabilizers, landing gear, manual door-opening controls etc.) and locking the interface of the airborne computers accessible from the cockpit.

In that way, nobody can send a control to the system, either through the computers of the aircraft or manually.

The aircraft becomes totally independent.

The computer can also automatically direct the aircraft to the airport selected during stage b) via a route that is determined automatically on the basis of the information supplied.

When the aircraft approaches the selected landing spot, the computer controls the automatic landing of the aircraft on the airport by means of the FMGC system and the autopilot. To that end, it may receive information fro the Ground Position Warning System (GPWS) and the Instrument Landing System (ILS) of the selected airport.

In a variant of the invention, during the final landing stage, when the aircraft is at a certain distance from the airport, the computer may give the controls back to a human pilot for better control of drag, flaps and landing gear during the landing procedure.

If the aircraft accelerates or increases its altitude at this point, the computer receives that information and locks the controls once again.

The computer may then control the automatic landing of the aircraft on the landing spot.

The method described in the invention advantageously includes an additional stage during which a signal relating to its use is transmitted to the ground.

If the procedure is started up due to an operator error, the method described in the invention also provides for a deactivation procedure.

That deactivation procedure is only possible when the system receives instructions from the ground and instructions from within the aircraft. Deactivation may for instance take place through a numerical keypad with self-protected codes, where half the code is on board and the other half is on the ground.

The method described in the invention may, for instance provide for a given safety time, say a few minutes, for using the deactivation procedure. In the absence of deactivation, the procedure is maintained.

The method described in the invention also contains a stage during which information about the selected landing airport and route is transmitted to the ground. In that way, air traffic controllers are informed of the direction taken by the hijacked aircraft, but cannot make the decision instead of the computer. That advantageously reduces the risk of an aircraft being hijacked from the ground.

The method also includes a stage where, providing the aircraft is appropriately equipped, the fuel that is not required for approach and landing on the selected airport is dumped.

The invention will become easier to understand after a reading of the detailed description below of a non-limitative example of embodiment of the invention and an examination of the enclosed chart. The single FIGURE represents a diagram of the various stages of the method.

If an aircraft is taken over by hijackers, the crew sets off the procedure described in the invention.

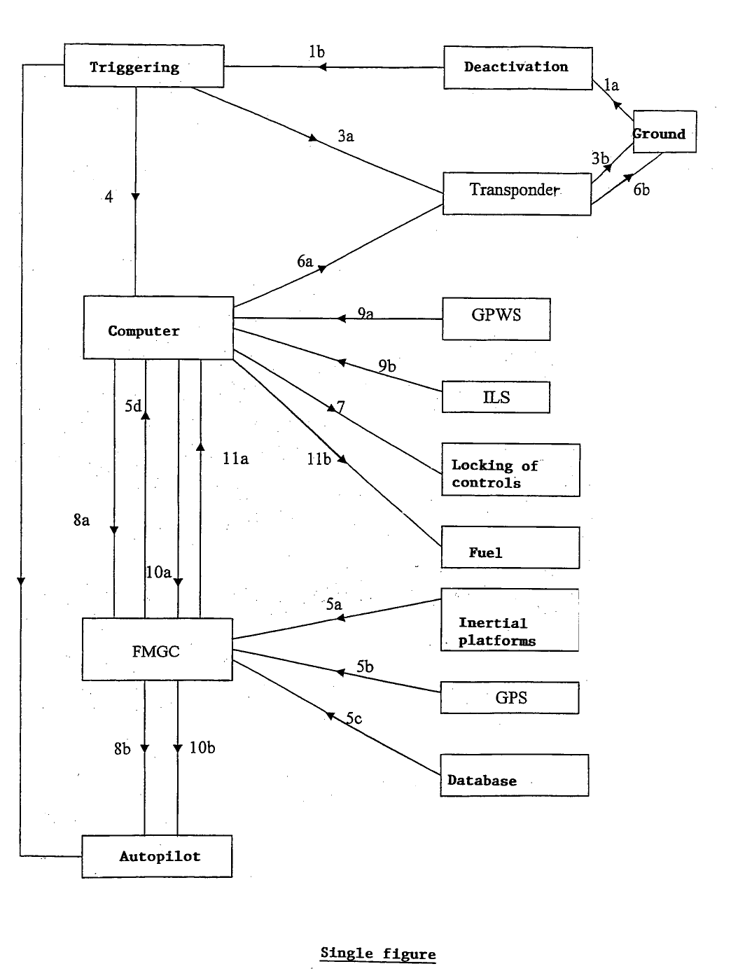

That automatically leads to the locking of the autopilot, as shown in point 2 of FIG. 1. In order to avoid accidental starting, a delay may be provided with a safety time for neutralizing the triggering phase.

Deactivation, which is shown in the FIGURE in points 1a and 1b, is possible by entering a code, half of which comes from the ground and the other half from inside the aircraft.

The information that the procedure has been triggered is transmitted to the ground via the transponder of the aircraft. That stage is shown in points 3a and 3b. Besides, the computer is activated as in point 4.

As shown in point 5d, the computer is then given a certain quantity of information via the FMGC in order to enable it to select an emergency landing airport and the route to get to the selected airport.

The information collected by the FMGC is particularly supplied as shown in point 5a by the inertial platforms and in point 5b by the GPS of the aircraft, for position data, and in point 5c by the databases saved in the aircraft as regards airports and their equipment systems, and the fuel remaining.

Once the airport and the route have been selected, the computer transmits information to the ground as shown in points 6a and 6b via the aircraft transponder.

As shown in point 7, the computer then locks any controls that can be activated from within the aircraft or from outside during flight, such as the secondary hydraulic controls (flaps, stabilizers, landing gear, manual door opening etc.) and the interfaces of airborne computers that are accessible from the cockpit.

Once the computer has locked all the controls, the route of the aircraft can no longer be modified.

The computer then supplies the FMGC with instructions relating to the selected route (point 8a). As shown in point 8b, the FMGC commands the autopilot to carry out its instructions.

Regardless of the position of the aircraft when the procedure is started, the computer automatically selects the highest altitude, whether the aircraft is in the approach phase, taking off or at cruising altitude.

When the approach phase starts, the Ground Position Warning System (GPWS) and the Instrument Landing System (ILS) supply the computer, as shown in 9a and 9b, with information for approach and landing. As shown in 10b, the computer transmits the instructions required to the FMGC, which transmits them as shown in 10b to the autopilot.

For aircraft with fuel dumping systems, stages 11a and 11b can be implemented. During the approach phase, the FMGC transmits information about the fuel level and the fuel required for approach and landing to the computer as shown in 11a. As shown in 11b, the computer transmits the instruction to dump the fuel from the fuel tank or tanks.

The aircraft can then land safely.

1. Method to prevent hijackers from directing an aircraft onto a target on the ground, characterized by the fact that it comprises the following stages:
a) Locking of the autopilot or autopilots
b) Selection of a landing airport by an airborne computer
c) Locking by the said computer of the controls accessible when the aircraft is airborne
d) Automatic guidance of the aircraft towards a route to the said selected landing airport
e) Automatic guidance of the aircraft for landing on the selected airport.

2. Method as described in claim 1, characterized by the fact that it comprises a stage preventing the reprogramming of the autopilot by any person or persons.

3. Method as described in claim 1, characterized by the fact that the choice of a landing airport in stage b) is made automatically on the basis of the data stored in the aircraft and the measurements made automatically.

4. Method as described in claim 1, characterized by the fact that between stages a) and b), there is a stage consisting in transmitting information about the start of the procedure to the ground.

5. Method as described in claim 1, characterized by the fact that between stages b) and c), there is a stage consisting in transmitting information about the selected landing airport and route to the ground.

6. Method as described in claim 1, characterized by the fact that between stages d) and e), there is a stage consisting in dumping extra fuel.

7. Method as described in claim 1 characterized by the fact that it includes a stage for deactivating the start of the procedure.

8. Method as described in claim 7, characterized by the fact that the said deactivation stage is implemented when instructions are received both from the ground and from within the aircraft.
